(19) United States
(12) Patent Application Publication
(10) Pub. No.: US 2014/0152086 A1
(43) Pub. Date: Jun. 5, 2014

(54) UNDERCARRIAGE TRACK LINK

(71) Applicant: CATERPILLAR INC., Peoria, IL (US)

(72) Inventors: Robert Lee Meyer, Metamora, IL (US); Michael Dean Hasselbusch, Metamora, IL (US); Gergory Wayne Tomlins, Peoria, IL (US)

(73) Assignee: Caterpillar Inc., Peoria, IL (US)

(21) Appl. No.: 13/690,615

(22) Filed: Nov. 30, 2012

(51) Int. Cl. B62D 55/21; C21D 8/00; B62D 55/14

(52) U.S. Cl. CPC B62D 55/21; B62D 55/14; C21D 8/005
USPC 305/142; 305/202; 148/653

(57) ABSTRACT

A track link is disclosed for use with an undercarriage of a machine. The track link may have a body with a first surface and a second surface opposite the first surface. The track link may also have a shoe face extending between the first and second surfaces at a side of the body, and a roller rail extending between the first and second surfaces at a side of the body opposite the shoe face, The body may have a substantially uniform hardness of about 45 to 55 Rkw C between the shoe face and the roller rail.

### TECHNICAL FIELD

The present disclosure relates generally to an undercarriage and, more particularly, to a track link for an undercarriage.

### BACKGROUND

Many mobile machines have tracked undercarriages that engage the ground as the machines travel. For example, earthmoving machines like tractors and excavators have such undercarriages. A typical undercarriage includes an endless track that rotates around a roller frame, The track is made of steel track links connected end-to-end via pins. The track links each include a rail that guides the track over rollers of a machine frame as the track rotates, The track links support the weight of the machine and must endure considerable stress, especially at the rail. The customary method of making track links with sufficient strength includes induction hardening of the rail.

While induction hardening of the rail may provide sufficient strength for some applications, the process is limited to a maximum hardened depth of about 20 mm, and can create a temperature gradient in the track links. The gradient produces a soft zone in the track below the hardened surface of the rail. The soft zone can significantly reduce the structural strength and fatigue life of the track links, and causes the track link to fail or to break during operation of the machine. Moreover, induction hardening is a costly manufacturing process.

The undercarriage track link of the present disclosure solves one or more of the problems set forth above and/or other problems in the art.

### SUMMARY

In one aspect, the present disclosure is directed to a track link. The track link may include a body with a first surface and a second surface opposite the first surface. The track link may also include a shoe face extending between the first and second surfaces at a side of the body, and a roller rail extending between the first and second surfaces at a side of the body opposite the shoe face. The body may have a substantially uniform hardness of about 45 to 55 Rkw C between the shoe face and the roller rail.

In another aspect, the present disclosure is related to a process of making a track link. The process may include fabricating a steel form with a first surface and a second surface opposite the first surface, and heating the steel form to create an austenite crystal structure throughout the steel form. The process may also include quenching the steel form to create a martensite crystal structure throughout the steel form, and tempering the steel form to create a substantially uniform hardness of about 45 to 55 Rkw C throughout the steel form. The process may further include machining the steel form after the fabricating, heating, quenching, and tempering.

### BRIEF DESCRIPTION OF THE DRAWINGS

FIG. 1 is a pictorial illustration of an exemplary disclosed undercarriage;

FIG. 2 is a pictorial illustration of an exemplary disclosed link assembly that may be used with the undercarriage of FIG. 1;

FIG. 3 is a pictorial illustration of an exemplary disclosed track link that may be used with the link assembly of FIG. 2;

FIG. 4 is a pictorial illustration of another exemplary disclosed link assembly that may be used with the undercarriage of FIG. 1;

FIG. 5 is a pictorial illustration of an inner track link that may be used with the link assembly of FIG. 4;

FIG. 6 is a cross-sectional side view illustration of the inner track link shown in FIG. 5;

FIG. 7 is a pictorial illustration of an outer track link that may be used with the link assembly of FIG. 4; and

FIG. 8 is a cross-sectional side view illustration of the outer track link shown in FIG. 7.

### DETAILED DESCRIPTION

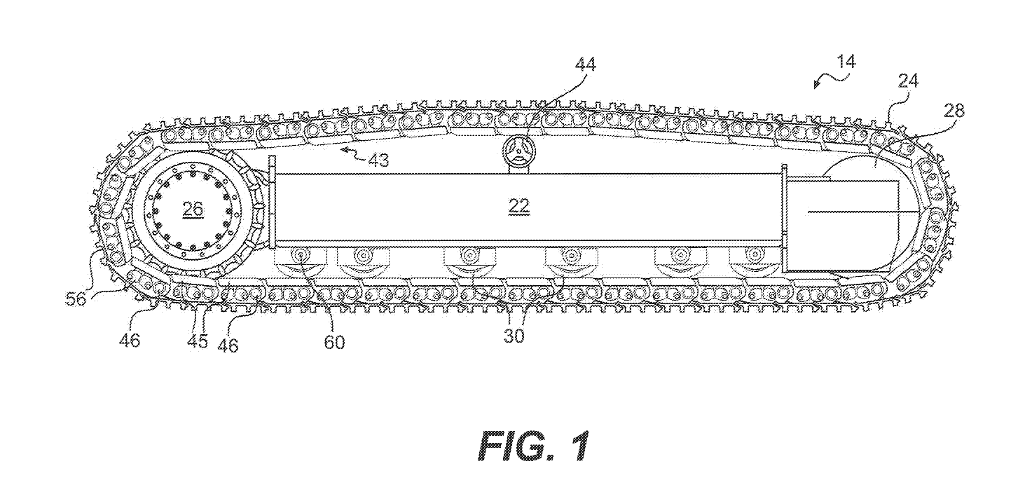

FIG. 1 illustrates an exemplary undercarriage 14 according to the present disclosure. Undercarriage 14 may be used with a mobile machine as the traction device that propels the machine. For example, undercarriage 14 may be attached to the chassis of an excavator having a pivotally supported superstructure. Undercarriage 14 may alternatively be used to propel another type of track-type machine.

Undercarriage 14 may be configured to support the associated machine and engage the ground, roads, and/or other types of terrain. Undercarriage 14 may include, among other things, a track roller frame 22, and an endless track 24 that engages guiding components of the track roller frame 22. In the embodiment shown in FIG. 1, the guiding components of undercarriage 14 include a drive sprocket 26, an idler 28, a plurality of lower rollers 30 and an upper carrier roller 44.

Track 24 may include a link assembly 43 that forms a flexible backbone of track 24, as well as a plurality of shoes 56 secured to link assembly 43. Link assembly 43 may include a plurality of individual links 45 connected end-to-end at pivot joints 46, Link assembly 43 may extend in an endless chain around drive sprocket 26, idler 28, lower rollers 30, and upper carrier roller 44. Shoes 56 may be secured to an outer perimeter of link assembly 43. For example, track 24 may include one shoe 56 attached to each link 45.

Upper carrier roller 44 may guide track 24 at an upper track side of roller frame 22. To do so, upper carrier roller 44 may extend upward from track roller frame 22 and engage an inner portion of link assembly 43. Upper carrier roller 44 may have various configurations. In some embodiments, upper carrier roller 44 may be substituted for multiple carrier rollers. In addition to or instead of rollers, carrier roller 44 may also include skids on which link assembly 43 slides.

Drive sprocket 26 and idler 28 may guide endless track 24. Drive sprocket 26 and idler 28 may be suspended from opposite ends of track roller frame 22. The endless chain formed by link assembly 43 may wrap around drive sprocket 26 and idler 28. One or more portions of drive sprocket 26 may project into spaces between links 45 for the transfer of tractive forces. Drive sprocket 26 and idler 28 may rotate about lateral axes to guide link assembly 43 through approximately semicircular paths between lower and upper portions of the endless chain formed by link assembly 43. Drive sprocket 26 may be rotated by a power source (not shown) of the associated machine to drive the movement of link assembly 43. Driven by sprocket 26, link assembly 43 may, in turn, rotate idler 28 and lower rollers 30 around their rotation axis. As shown in FIG. 1, drive sprocket 26 may be located adjacent the ground at a height approximately the same as idler 28. Alternatively, in some embodiments, drive sprocket 26 may be elevated above the ground at a height significantly greater than idler 28. For example, drive sprocket 26 may be positioned above track roller frame 22. In this configuration, an additional idler (e.g., a rear idler—not shown) may be positioned at an end of track roller frame 22 opposite idler 28.

Lower rollers 30 may guide track 24 at a lower side of track roller frame 22. Lower rollers 30 may each be suspended from track roller frame 22. For example, each of lower rollers 30 may be rotationally supported on an axle 60 suspended below track roller frame 22. Lower rollers 30 may ride on and guide links 45 of link assembly 43.

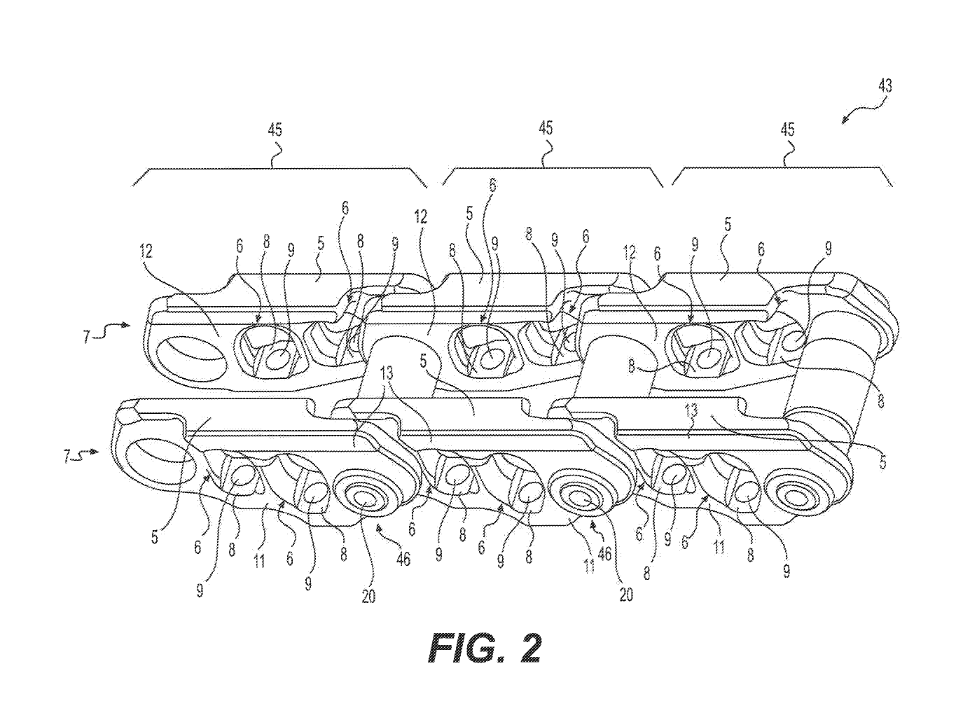

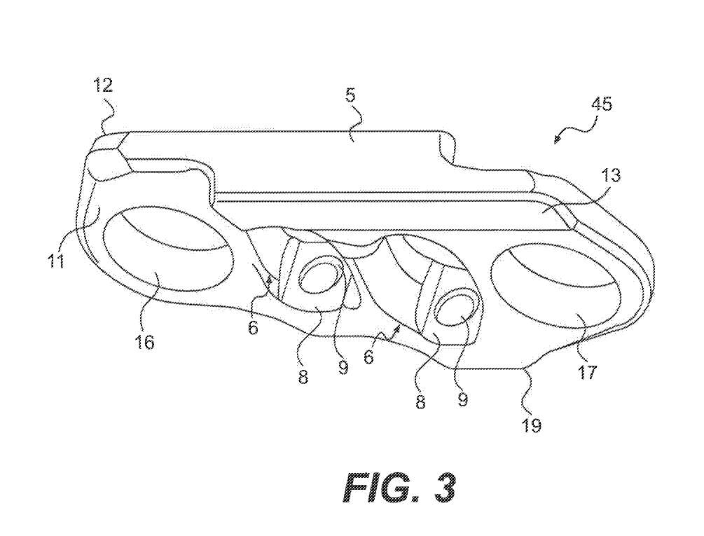

FIG. 2 shows an exemplary portion of link assembly 43 having links 45 assembled into laterally spaced pairs connected to one another with pins 20 at pivot joints 46. Each pair may include two links 45 that are mirror images of each other. As shown in FIGS. 2 and 3, each link 45 may include an outer surface 11 and an inner surface 12, with inner surfaces 12 of paired links 45 facing each other. Additionally, each of links 45 may include a rail 5 that is generally perpendicular to and joins outer and inner surfaces 11, 12, Rail 5 may be configured to engage and support rollers 30 and 44 (referring to FIG. 1) of undercarriage 14 during operation of the associated machine. Rails 5 of links 45 may be arranged into two generally parallel and spaced apart rows 7 of aligned engagement surfaces.

As also shown in FIGS. 2 and 3, links 45 may have contoured surfaces with a plurality of different recesses and projections. For example, rail 5 of each link 45 may be generally wider at a middle section, and narrower at opposing ends. In addition, the opposing ends may be laterally offset from each other. With this configuration, the narrower ends of connected links 45 may collectively provide a bearing surface of substantially the same width as that provided by the middle section of each rail 5. This may give each row 7 of rails 5 a substantially constant width, while also helping to ensure that each of rails 5 presents a substantially continuous and straight outer guide surface 13 with which rollers 30 and 44 can remain continuously engaged.

Opposite rails 5, links 45 may include provisions for attaching track shoes 56 (referring to FIG. 1) to links 45. In particular, each link 45 may include a plurality of holes 9 configured to receive fasteners (not shown) passing from an associated track shoe 56 through link 45. In some embodiments, holes 9 may be threaded to receive the fasteners. In other embodiments, one or more windows 6 may extend between outer and inner surfaces 11 and 12 to provide seating surfaces 8 for nuts or other devices (not shown) that engage distal ends of the fasteners. To secure a track shoe 56 to a particular link 45, the track shoe 56 may be placed against a shoe face 19 (referring to FIG. 3) of the link 45, and the fasteners may be inserted through the track shoe 56 and holes 9 in the link 45 to either engage the threading of holes 9 or the nut within window 6.

Shoe face 19 may extend transversely between outer surface 11 and inner surface 12 at one end of each track link 45. Rail 5 may extend between outer surface 11 and inner surface 12 at a side opposite shoe face 19. As show in FIG. 3, link 45 may further include first and second pin openings 16, 17 that extend from outer surface 11 through inner surface 12 and are spaced apart along a length direction of link 45, both configured to receive a single pin 20 (referring to FIG. 2). Windows 6 may be formed between first and second pin openings 16, 17.

Track link 45 may have varying configurations and contours. For example, the location of windows 6, first pin opening 16 and second pin opening 17 may be positioned at different locations on track link 45 those shown in FIGS. 2 and 3. Similarly, the contours of outer surface 11 and inner surface 12 may vary from those shown in FIGS. 2 and 3.

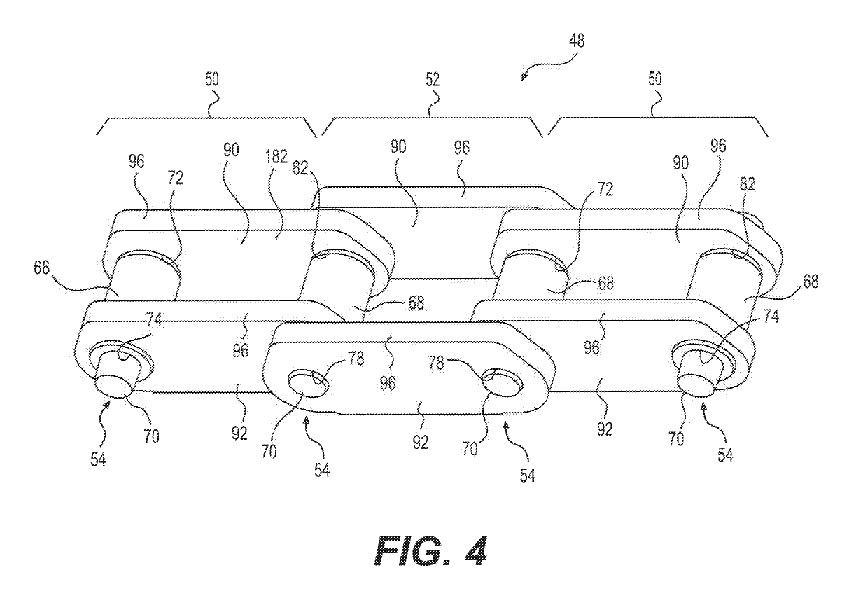

FIG. 4 illustrates an alternative link assembly 48 that may be used with undercarriage 14. Link assembly 48 may include laterally spaced pairs of links 50 alternating with laterally spaced pairs of links 52. As shown in FIGS. 4-8, links 50, 52 may be relatively simple, block-like links, as compared to links 45 described above. Opposing ends of links 50 may be positioned laterally between adjacent ends of links 52. Thus, the lateral spacing between each pair of links 52 may be greater than the lateral spacing between each pair of links 50. Accordingly, links 50 may be considered inner links, and links 52 may be considered outer links.

Links 50, 52, like links 45 described above, may be connected end-to-end at pivot joints 54. The connection at each pivot joint 54 may be accomplished by way of a bushing 68 and a pin 70. In particular, each inner link 50 may include a first opening 72 and a second opening 82 that are spaced apart from each other along a length of link 50. Each of first opening 72 and a second opening 82 may be configured to receive bushings 68. In some embodiments, first and second openings 72, 82 of paired inner links 50 may be press-fitted onto the ends of two different bushings 68 until inner links 50 engage shoulders of bushings 68. This may fix inner links 50 in a laterally spaced relationship to one another on bushings 68. In some embodiments, the ends of each bushing 68 may protrude slightly from inner links 50. Alternatively, the ends of bushings 68 may be flush with or recessed within inner links 50.

Each bushing 68 may itself have a through-bore 74. One of pins 70 may be installed in the through-bore 74 of each bushing 68. Each pin 70 may be longer than each bushing 68, such that each end of pin 70 may protrude beyond each end of bushing 68 receiving pin 70. The through-bore 74 of each bushing 68 and each pin 70 may be configured so that each pin 70 can rotate relatively freely within through-bore 74 of bushing 68. For example, each pin 70 may have an outer diameter smaller than the inner diameter of through-bore 74.

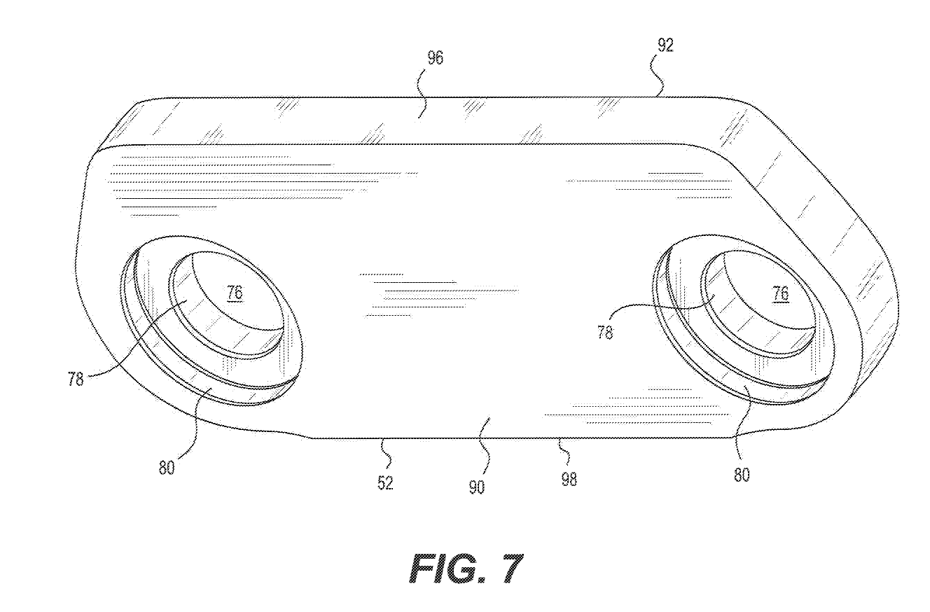

Each of outer links 52 may include provisions for registering with portions of bushings 68 and/or pins 70 protruding from inner links 50. For example, as shown in FIG. 7, each of outer links 52 may include a pair of openings 76. Each opening 76 may include a pin bore 78 configured to receive an end of a corresponding pin 70, as well as a counterbore 80 configured to register with the end of one of bushings 68. Each counterbore 80 may be sized to allow clearance around the end of bushing 68, so that bushing 68 and outer link 52 may rotate freely relative to one another about the axis of pin 70 and bushing 68. In some embodiments, pin bore 78 may be sized to have a press fit with the end of pin 70.

As shown in FIGS. 4-8, inner and outer links 50 may have a monolithic construction with substantially planar inner and outer surfaces 90, 92. Inner and outer surfaces 90, 92 may also omit the windows 6 and seats 8 of links 45 described above. Omitting windows 6 and seats 8 may tend to enhance the strength of inner and outer links 50, 52, while also lowering the cost of manufacture.

A rail 96 may be formed at the top side of each of inner and outer links 50, 52, and a shoe face 98 may be formed at the bottom side opposite rail 96. In some embodiments, rail 96 and shoe face 98 may both be substantially straight and planar, as well as parallel to one another. Alternatively, rail 96 and/or shoe face 98 may have other shapes. For example, in some embodiments, rail 96 may arch away from shoe face 98 as it extends toward the longitudinal center of inner and/or outer links 50, 52. Additionally, shoe face 98 may include one or more arches and/or projections, if desired.

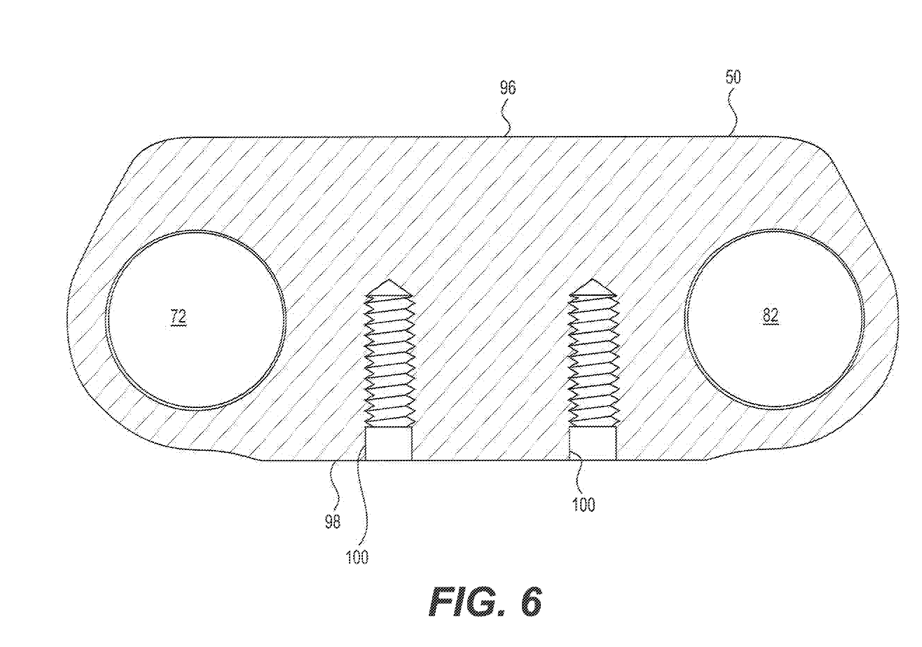

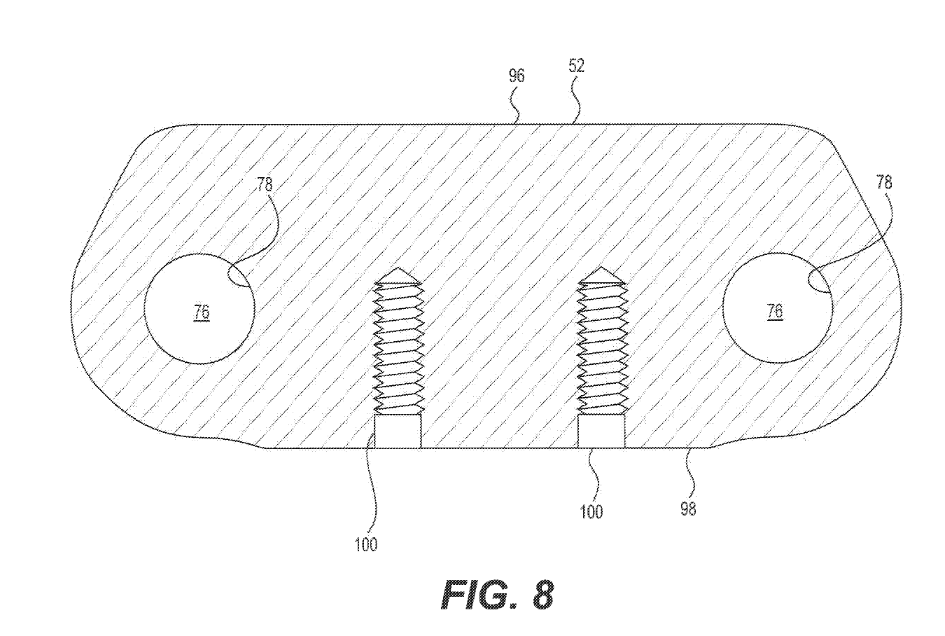

As shown in FIGS. 6 and 8, inner link 50 and outer link 52 may include mounting structure configured to secure a track shoe 56. With no windows or seats in inner and outer links 50, 52, the mounting structure may take various forms. In some embodiments, the mounting structure may include threaded holes 100 extending from shoe face 98 into the body of inner and outer links 50, 52 toward rail 96. In some embodiments, holes 100 may include counterbores to facilitate achieving relatively large amounts of bolt stretch in the hardware used to mount shoe 56 to inner and outer links 50, 52, This may help ensure that shoe 56 remains securely connected to inner and outer links 50, 52.

Each track link 45, 50 and 52 described above may be made of a material strong enough to bear the weight of the associated machine, and have a substantially uniform hardness throughout the entire track link. For example, track links 45, 50 and 52 may be made of steel and have a relatively consistent hardness of about 45 to 55 Rkw C between shoe face 19, 98 and rail 5, 96.

### INDUSTRIAL APPLICABILITY

The disclosed track link embodiments may have use in any tracked undercarriage application. The configurations of the disclosed track link embodiments may provide a number of benefits, including efficient manufacturing. In particular, because the disclosed track links may have substantially uniform hardness throughout, the additional step of induction hardening these links may not be required. Additionally, the disclosed embodiments may have greater durability and strength than known configurations. Specifically, because the disclosed links may be fabricated without induction hardening, soft spots normally associated with the hardening process may be eliminated. The process of manufacturing track links 45, 50 and 52 will now be described in detail.

The basic form of links 45 may be fabricated through a forging process, while the basic forms of links 50 and 52 (because of their simpler shapes) may be fabricated via cutting of steel sheet stock. In both embodiments, the forms may be fabricated from at least one of SAE 15B35 or SAE 41B35 steel. Alternatively, the forms may be made of steel having a composition, by weight percent, of about 0.20 to 0.45% carbon, about 0.4 to 1.5% manganese, about 0.5 to 2.0% silicon, about 0.01 to 2.0% chromium, about 0.15 to 1,2% molybdenum, about 0.01 to 0.40% vanadium, about 0.01 to 0.25% titanium, about 0.005 to 0.05% aluminum, about 0.0001 to 0.010% boron, less than about 0.002% oxygen, about 0.005 to 0.017% nitrogen, and a balance of essentially iron.

In one embodiment, the basic forms of link 45 may be fabricated by forging steel forms at a temperature of approximately 1000-1250° C. After forging the steel forms and before the steel forms cool, the forms may he quenched, such that a marten site crystal structure is created throughout the forms. The quenching may be implemented by putting the forged steel forms in a quenching fluid, such as water, soluble oil, or another oil. The quenched steel forms may then be tempered to achieve a substantially uniform hardness of about 45 to 55 Rkw C. In one embodiment, the tempering may be achieved by heating the quenched steel forms substantially uniformly at a temperature of approximately 150-200° C. for approximately 30-60 minutes.

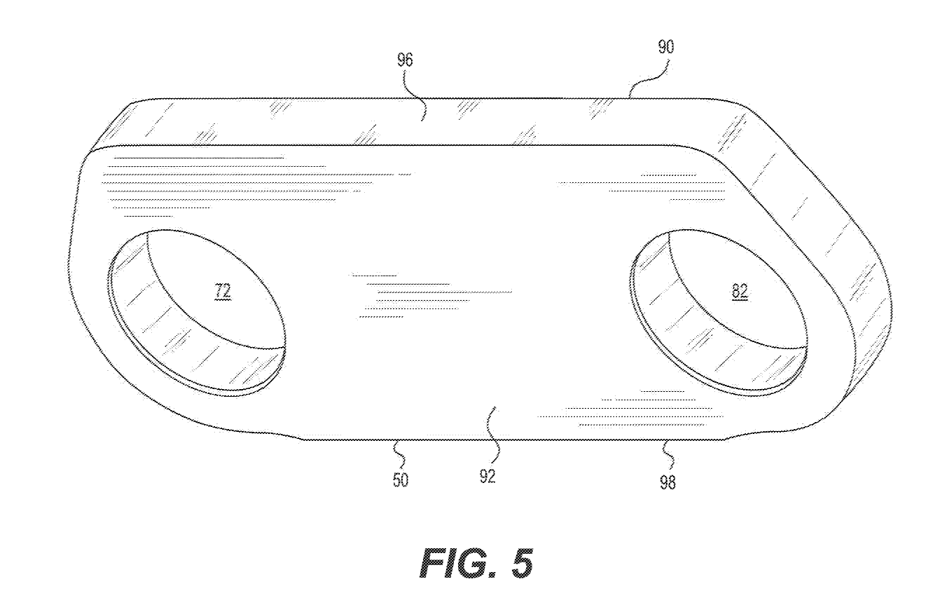

The tempered steel forms may then he machined into their final shapes. Machining may be performed with a cutting tool that is cooled by liquid nitrogen or liquid carbon dioxide in order to inhibit overheating caused by the machining process. The machining may he performed to create shoe faces 19, 98; rails 5, 96; and openings 16, 17, 72, 76, 82. In the embodiment shown in FIG. 3, windows 6, seats 8 and holes 9 may also be fabricated by machining the steel form. In the embodiment shown in FIGS. 5-8, mounting holes 100 may he created by machining the steel forms.

In an alternative embodiment, the basic forms of link 45 or links 50 and 52 may include cooling the steel forms to room temperature after forging or cutting them from steel sheet stock and heating the basic forms at a sufficient temperature and duration to form an austenite crystal structure throughout the forms. In one embodiment, the heating may be performed at a temperature of approximately 750-1000° C. for a duration of approximately 30-60 minutes. The heating of the steel forms may be performed in a furnace in order to heat all parts of the forms substantially uniformly. The forms may he heated, quenched, tempered, and machined according to the same parameters of the embodiment described above. The forged links that are allowed to cool to room temperature before the heating, quenching, tempering, and machining step have a smaller grain size than the forged links that are quenched, tempered, and machined directly after the forging step.

The processes described above may be performed to create track links with a uniform hardness of about 45 to 55 Rkw C. The processes may not require induction heating and, for this reason, may avoid temperature gradients in the links during the hardening process. By avoiding the temperature gradient, the track links may avoid soft zones below the surface of the rails. This should make the track links less likely to fail or break during operation of the associated machine. Moreover, the process described above may allow for cost efficient production by avoiding the energy-intensive process step of induction heating.

It will be apparent to those skilled in the art that various modifications and variations can be made to the disclosed undercarriage track links without departing from the scope of the disclosure. Other embodiments of the undercarriage will be apparent to those skilled in the art from consideration of the specification and practice of the undercarriage track links disclosed herein. It is intended that the specification and examples be considered as exemplary only, with a true scope of the disclosure being indicated by the following claims and their equivalents.

What is claimed is:

1. A track link, comprising:
a body having a first surface and a second surface opposite the first surface;
a shoe face extending between the first and second surfaces at a side of the body; and
a roller rail extending between the first and second surfaces at a side of the body opposite the shoe face,
wherein the body has a substantially uniform hardness of about 45 to 55 Rkw C between the shoe face and the roller rail.

2. The track link of claim 1, further including:
a first pin opening extending from the first surface to the second surface; and
a second pin opening extending from the first surface to the second surface and spaced apart along a length direction of the body.

3. The track link of claim 2, wherein the first and second surfaces are substantially planar and parallel to one another.

4. The track link of claim 3, wherein the track link further includes a mounting hole extending from the shoe face into the body toward the roller rail.

5. The track link of claim 4, wherein the mounting hole is threaded.

6. The track link of claim 1, wherein the roller rail projects away from the body at the first surface.

7. The track link of claim 2, further including:
a first window extending from the first surface toward the second surface;
a second window extending from the first surface toward the second surface; and
a seat formed within each window.

8. The track link of claim 1, wherein the body is made from at least one of SAE 15B35 or SAE 41B35 steel.

9. The track link of claim 1, wherein the body is made of steel having a composition, by weight percent, of about 0.20 to 0.45% carbon, about 0.4 to 1.5% manganese, about 0.5 to 2.0% silicon, about 0,01 to 2.0% chromium, about 0.15 to 1.2% molybdenum, about 0.01 to 0,40% vanadium, about 0.01 to 0.25% titanium, about 0.005 to 0.05% aluminum, about 0.0001 to 0,010% boron, less than about 0.002% oxygen, about 0.005 to 0.017% nitrogen, and a balance of essentially iron.

10. A process of forming a track link, comprising:
fabricating a steel form with a first surface and a second surface opposite the first side;
heating the steel form to create an austenite crystal structure throughout the steel form;
quenching the steel form to create a martensite crystal structure throughout the steel form:
tempering the steel form to create a substantially uniform hardness of 45 to 55 Rkw C throughout the steel form; and
machining the steel form after the fabricating, heating, quenching, and tempering.

11. The process of claim 10, wherein machining includes;
cutting a shoe face into the steel form; and
cutting a roller rail into the steel form opposite the shoe face.

12. The process of claim 11, wherein heating includes heating the steel form for approximately 30-60 minutes at approximately 750-1000° C.

13. The process of claim 11, wherein heating includes heating the steel form in a furnace.

14. The process of claim 11, wherein cutting of the shoe face and roller rail is performed with a cutting tool cooled by liquid nitrogen or liquid carbon dioxide.

15. The process of claim 11, wherein machining further includes:
cutting a first pin opening from the first surface to the second surface at a first lengthwise end of the steel form; and
cutting a second pin opening from the first surface to the second surface at an opposing second lengthwise end of the steel form.

16. The process of claim 11, wherein the steel form is fabricated from at least one of SAE 15B35 and SAE 41B35 steel.

17. The process of claim 11, wherein tempering the steel form includes heating the steel form at a temperature of approximately 150-200° C.

18. The process of claim 17, wherein tempering is performed for approximately 30-60 minutes.

19. The process of claim 11, wherein the steel form has a composition, by weight percent, of about 0.20 to 0.45% carbon, about 0.4 to 1.5% manganese, about 0.5 to 2.0% silicon, about 0.01 to 2.0% chromium, about 0.15 to 1.2% molybdenum, about 0.01 to 0.40% vanadium, about 0.01 to 0.25% titanium, about 0.005 to 0.05% aluminum, about 000001 to 0.010% boron, less than about 0.002% oxygen, about 0.005 to 0.017% nitrogen, and a balance of essentially iron.

20. An undercarriage assembly, comprising:
a track roller frame;
a plurality of track links, each track link of the plurality of track links pivotally connected to an adjacent track link of the plurality of track links via a respective pivot joint, such that the plurality of track links forms an endless chain; and
a plurality of rollers, configured to engage the plurality of track links,
wherein:
each track link of the plurality of track links includes:
a body having a first surface and a second surface opposite the first surface;
a shoe face extending between the first and second surfaces at a side of the body; and
a roller rail extending between the first and second surfaces at a side of the body opposite the shoe face;
the body has a substantially uniform hardness of about 45 to 55 Rkw C between the shoe face and the roller rail; and
the body is made of steel having a composition, by weight percent, of about 0.20 to 0.45% carbon, about 0.4 to 1.5% manganese, about 0.5 to 2.0% silicon, about 0.01 to 2.0% chromium, about 0.15 to 1.2% molybdenum, about 0.01 to 0.40% vanadium, about 0.01 to 0,25% titanium, about 0.005 to 0.05% aluminum, about 0.0001 to 0.010% boron, less than about 0.002% oxygen, about 0.005 to 0.017% nitrogen, and a balance of essentially iron.
